(19) United States
(12) Patent Application Publication
(10) Pub. No.: US 2003/0112355 A1
(43) Pub. Date: Jun. 19, 2003

(54) Dual purpose viewfinder

(76) Inventor: Wilfried Bittner, Hong Kong (CN)

Correspondence Address: Concord Camera Corp., 4000 Hollywood Blvd., Suite 650N, Hollywood, FL, 33021, US

(21) Appl. No.: 10/016,648

(22) Filed: Dec. 17, 2001

(51) Int. Cl. H04N 5/222

(52) U.S. Cl. 348/333.01

(57) ABSTRACT

A dual-purpose camera viewfinder is provided. The viewfinder is operable in a framing mode and in a review mode. In the framing mode, the camera provides a direct line-of-sight through the viewfinder for live viewing. In the review mode, an angled flipping mirror is raised into the viewfinder line-of-sight and permits the user to view stored images reflected from an internal display through the viewfinder ocular lens. A loupe lens magnifies the image from the display and directs the image to the angled flipping mirror. Additionally, entering the review mode closes an electrical circuit that signals the processor to selectively power the display and to control the display of the stored images.

### FIELD OF THE INVENTION

The present invention relates to the field of cameras and, more particularly, to a dual-purpose viewfinder for a digital camera.

### BACKGROUND OF THE INVENTION

The use of digital cameras has increased greatly over the past few years and, with the advances in computer and related technologies and the advent of the internet, is expected to increase even more in the years to come. These days, digital cameras and the related technologies not only allow image capture, storage, downloading and manipulation, but also allow such images to be electronically, and in some instances wirelessly, transmitted anywhere in the world.

The digital camera industry, like other technology industries, is constantly striving to reduce the size of products, while maintaining or increasing the product's functionality. However, prior art digital cameras include certain inherent deficiencies, which hinder their ability to become smaller. For instance, prior art digital cameras utilize a liquid crystal display (“LCD”) to frame the image to be captured and to view the actual image captured. Of course, the LCD must be large enough to enable the user to adequately view the image being framed and captured. By employing a LCD for such purposes, the camera must have a sufficiently large surface area on which the LCD will be mounted. Thus, the LCD is a limiting factor in the ability to reduce the size of the camera.

In addition to the size limitation issue, the use of LCDs in digital cameras gives rise to several other problems. Specifically, LCDs have relatively high power demands causing batteries to drain quickly. Thus, it may be necessary for users to carry extra batteries with them so that they may continue using the camera. Furthermore, employing LCDs to frame an object, especially non-stationary objects, is somewhat cumbersome because the camera must be held away from the user's body some distance so that the user can view the LCD. Framing objects in such a manner differs greatly from means traditionally employed in non-digital cameras, that is, placing the user's eye up against the viewfinder or ocular lens. Moreover, LCDs frequently experience problems of washout or glare when they are used in bright ambient conditions.

The above described problems also impact the camera design and cost, by requiring a larger case, adequate gripping means to hold the camera away from the user's body, anti-glare means, and circuitry to provide the necessary power to the LCD. Additionally, the ability to create innovative and aesthetically pleasing external designs is limited by the need to provide a sufficiently large and flat surface area to accommodate the LCD. Without the ability to create such innovative designs, certain market segments may be unattainable.

Many prior art digital cameras also utilize removable memory disks or cards to store captured images. Such disks also impact the camera's size and configuration. Moreover, these external disks are relatively expensive and, depending upon the number of images to be captured, may require the user to carry one or more additional disks separate from the camera, thereby making transportability more difficult and creating the possibility of losing the disks, as well as any images recorded thereon.

Accordingly, there is a need in the art for a new and improved digital camera, which does not employ a LCD for image framing and capture and does not require an external memory, thereby minimizing the overall camera size, allowing for greater creativity in camera packaging and improving transportability. Any such camera should have relatively low power consumption requirements, thereby improving battery life over prior art digital cameras. Additionally, any such camera should be compact, lightweight and inexpensive. The present invention is particularly suited to overcome those problems which remain in the art in a manner not previously known.

### SUMMARY OF THE INVENTION

The present invention is directed to a compact digital camera including a new and improved dual-purpose viewfinder assembly. The viewfinder optical system is switchable between a “shooting mode”, where light is directed through the viewfinder objective lens to the viewfinder ocular lens, and a “review mode”, where light is directed from a display associated with the viewfinder to the ocular lens.

It is an object of the present invention to provide a camera which is compact and lightweight.

It is also an object of the present invention to provide such a camera which allows for greater creativity in camera packaging.

It is yet another object of the present invention to provide such a camera which has relatively low power consumption requirements, thereby improving battery life over prior art digital cameras.

It is a further object of the present invention to provide such a camera which does not employ a LCD for image framing and capture.

It is yet a further object of the present invention to provide such a camera which does not require an external memory, thereby improving transportability over prior art digital cameras.

These and other objects and advantages of the present invention will become more readily apparent in the description which follows.

### BRIEF DESCRIPTION OF THE DRAWINGS

The foregoing summary, as well as the following detailed description of the preferred embodiments, is better understood when read in conjunction with the appended drawings. For the purpose of illustrating the invention, there is shown in the drawings an exemplary embodiment that is presently preferred it being understood, however, that the invention is not limited to the specific methods and instrumentality's disclosed. Additionally, like reference numerals represent like items throughout the drawings. In the drawings:

FIG. 1A shows a perspective view from the front, right side of an exemplary camera useful with the present invention.

FIG. 1B shows a perspective view from the rear, right side of the camera of FIG. 1A.

FIG. 2A is a side cross-sectional diagram of one embodiment of the dual-purpose viewfinder of the present invention.

FIG. 2B is a front cross sectional view of one embodiment of the dual-purpose viewfinder of the present invention.

FIG. 3 is a block diagram of a circuit for reviewing the stored images in one particular embodiment of the present invention.

FIG. 4A is a perspective view taken from the front right side of a portion of the digital camera body portion including a dual purpose viewfinder in accordance with one particular embodiment of the present invention.

FIG. 4B is a perspective view taken from the rear right side of a portion of the digital camera body portion including a dual-purpose viewfinder in accordance with one particular embodiment of the present invention.

### DETAILED DESCRIPTION OF THE PREFERRED EMBODIMENTS

Before explaining the disclosed embodiments of the present invention in detail, it is to be understood that the invention is not limited in its application to the details of the particular arrangement shown since the invention is capable of other embodiments. Also, the terminology used herein is for the purpose of description and not of limitation.

The present invention is directed towards a compact digital camera including an inexpensive dual-purpose viewfinder assembly. The viewfinder includes a flipping mirror which is flipped down outside the line-of-sight through the viewfinder when the camera is operational in a first “shooting mode”. The flipping mirror is optically aligned !between a microdisplay and the ocular lens of the viewfinder in a second “review mode”. In one particular embodiment of the camera assembly, the viewfinder is disposed directly in the line-of-sight through the viewfinder, between the ocular lens and the objective lens, when the camera is switched to a second “review mode”, thus reflecting an image from a microdisplay to the eye of the viewer.

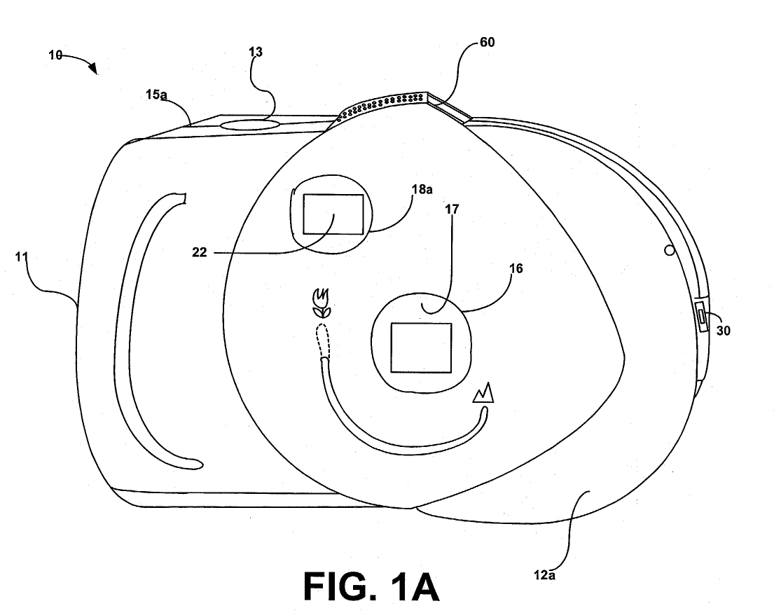

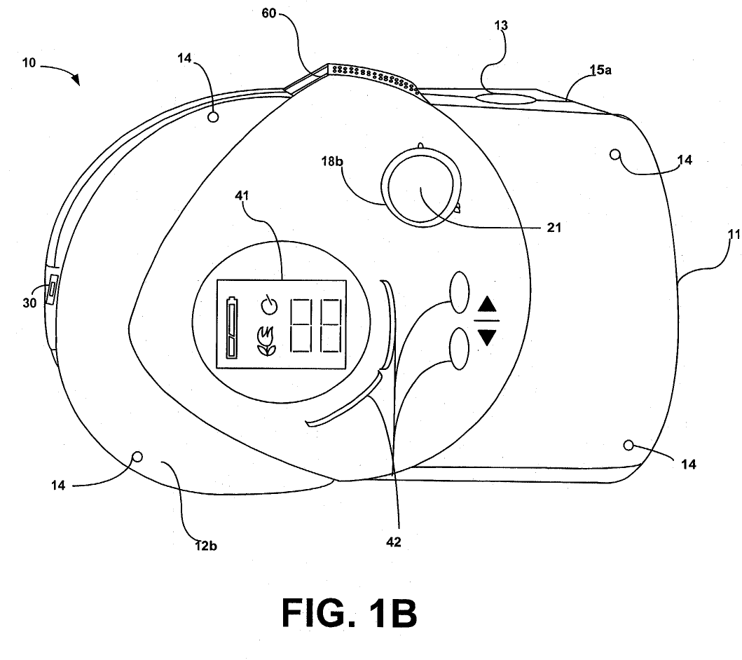

Referring now to FIGS. 1A and 1B, the camera 10 includes an outer housing 11 having a front portion 12a and a back portion 12b. The front portion 12a and the back portion 12b are made as two separate pieces to facilitate manufacturing of the housing 11. It should be appreciated, however, that the housing may, alternatively, be comprised of any number of pieces. Additionally, the outer surfaces of the front 12a and back 12b portions may be contoured, if desired, to improve gripping capabilities and provide a more ergonomic and aesthetically pleasing design. In the preferred embodiment, the housing 11 is constructed of a lightweight, yet rugged plastic material, but may, alternatively, be constructed of an alloy material, a metallic material or any other suitable material.

Front portion 12a of housing 11 is adapted for connective engagement with the corresponding back portion 12b using conventional fastening means. The two halves form a substantially light tight connection when assembled together. In the present embodiment, the front and rear portions 12a and 12b are secured together using screws 14.

The top and bottom halves 12a, 12b include a plurality of openings integrally formed therein. The openings are structured and disposed to allow access to the objective lens unit (opening 16), the viewfinder assembly (openings 18a and 18b), function select controls 42 and external connector 30.

The openings include an objective aperture 16 formed in a front face 12a of the housing 11. The objective aperture 16 is disposed within the objective lens optical axis and is adapted for receiving and holding an objective lens cover 17. The objective lens cover 17 may be formed of a transparent material such as glass or plastic and may include an opaque portion disposed about its outer perimeter to provide some undesired light shielding capabilities. The objective aperture 16 preferably has a circular shape.

An ocular lens aperture 20 is integrally formed in the rear housing 12b. The ocular lens aperture 20 is disposed within the ocular lens optical axis and is adapted for receiving and holding an ocular lens cover 21. The ocular lens cover 21 is formed of a transparent material such as glass or plastic. The ocular lens aperture 20 preferably has a substantially circular shape.

In the present camera 10, a direct line-of-sight through the viewfinder is accommodated by front and rear viewfinder openings 18a, 18b, which are integrally formed in the front and rear housings, respectively. An eye lens optical axis can be defined through the viewfinder apertures 18a and 18b, and correspondingly, through the viewfinder lenses 21 and 22. Additionally, as can be seen, the viewfinder lenses 21 and 22 are aligned together on the same plane.

A trigger button 13 is accessible through an opening disposed on the top face 15a of the housing 11.

An external interface cavity 30 is also integrally formed in the camera housing 11 and is accessible by moving the interface door 31. External interfaces are disposed within the external interface cavity 30 for interconnection with an external device, such as a computer, printer, television or video monitor, imaging device, etc.

A status indicator opening 40 is provided through the rear housing 12b. A status LCD 41 is mounted on the rear housing 12b. Additional openings for a number of user select buttons 42 are additionally provided through the rear housing, and are disposed in close proximity to the status indicator. The number and orientation of the user select buttons 42 may vary to accommodate the particular camera 10 layout. Similarly, the functions provided may vary. Typical function selects include, on/off, timer on/off, etc. Additionally, the status LCD 41 may provide a variety of desired information including timer indication, battery status, number of remaining pictures, mode indicator, etc.

A mirror slide switch 60 is slideably engaged with the top face 12c of the housing 11. The operation and function of mirror slide switch 60 will be described more fully in connection with certain embodiments of the present invention.

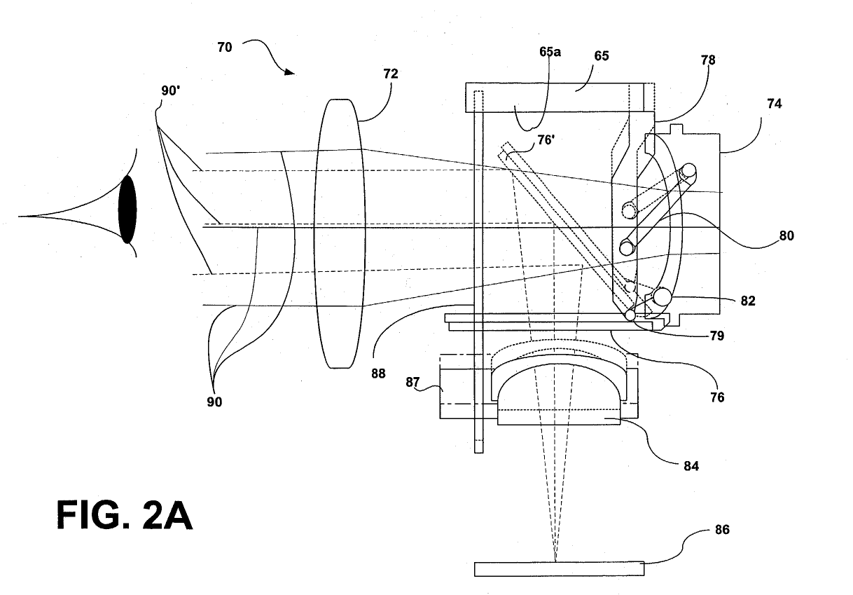

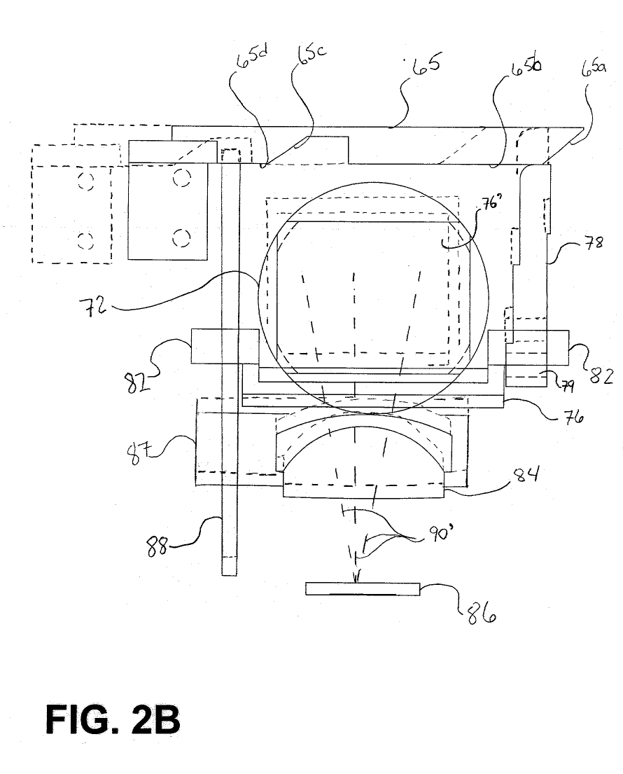

Referring now to FIGS. 2A and 2B there is shown a block diagram of a dual-purpose camera viewfinder in accordance with one particular embodiment of the present invention. The dual-purpose viewfinder assembly 70 of the present invention is moveable between a first live image or “shooting mode” (shown in solid lines) and a second stored image or “review mode” (shown in phantom). In the present embodiment, in order to keep the cost low, the viewfinder system 70 of the present embodiment is built around a simple reverse Galilean viewfinder. A positive ocular lens 72 is placed in direct physical and optical alignment with a negative objective lens 74. A flipping mirror 76 is disposed directly between the positive and negative lenses 72, 74.

The flipping mirror 76 is operated between a folded position and a raised position by a mirror plunger 78. Mirror plunger 78 includes an axial bore therethrough, which cooperates with a projection 79 on the mirror housing. The mirror housing additionally includes two pivot arms 82 which engage corresponding sleeve projections on the viewfinder housing (not shown), permitting the mirror 76 to pivot downward in response to depression of the mirror plunger 78.

The sliding mirror switch (60 of FIGS. 1A and 1B) provides an external user interface to manually switch the camera between the shooting and review modes. The sliding mirror switch engages an underlying review cam slide 65 of the viewfinder assembly 70. When first switched to the shooting mode, a first cam surface 65a and bottom surface 65b of the review cam slide 65 engage and lock the mirror plunger 78 into its depressed position. Depression of the mirror plunger 78 folds the mirror 76 out of the view path and additionally stretches the linked coil spring 80. As such, the line of sight through the viewfinder is clear, following lines 90 from the positive lens through the negative lens.

When the switch (60 of FIGS. 1A and 1B) is in the review mode position, a previously stored image can be reviewed on an internal microdisplay 86 from the ocular lens 72. In operation, when the switch (60 of FIGS. 1A and 1B) is manually moved, the underlying review cam slide 65 releases the mirror plunger 78 and the coil spring 80 returns to its compressed state, thus raising the mirror 76 to its raised position. In the raised position, the mirror 76 is angled at about 45 degrees. The viewfinder housing may include a mirror stop surface (not shown) to restrict the range of motion of the mirror 76 to ensure that the mirror 76 is held at the correct viewing angle.

In the present embodiment, a magnifying loupe 84 is disposed above a microdisplay 86 in a direct line with the mirror 76. In the review mode, images displayed on the microdisplay 86 are magnified by the magnifying loupe 84, reflected from the mirror 76 and viewed through the positive lens 72 of the viewfinder. The line of sight through the viewfinder assembly 70 follows the path 90′ in the review mode.

The magnifying loupe 84 may be fixed above the microdisplay a set distance to provide magnification for the image on the microdisplay 86. Alternatively, as shown in the current embodiment, a diving lens group may be provided that moves the magnifying loupe 84 to make room for the flipping mirror 76 in its folded position. When depressed, the loupe barrel guide pin 88 engages the loupe lens group housing 87 and operates to move the loupe lens group into a storage position, towards the microdisplay 86. In the present embodiment, the second cam surface 65c and bottom surface 65d on the review cam slide 65 engage and lock the loupe barrel guide pin 88 when the slide plate 65 is moved into the shooting mode position. This makes room inside the viewfinder assembly 70 for the mirror 76, in its folded position. When the slide plate 65 is moved to the review mode position, the loupe barrel guide pin 88 is released and a coil spring (not shown) attached between the lens barrel housing 87 and the viewfinder housing returns the magnifying loupe 84 to the desired position above the microdisplay 86.

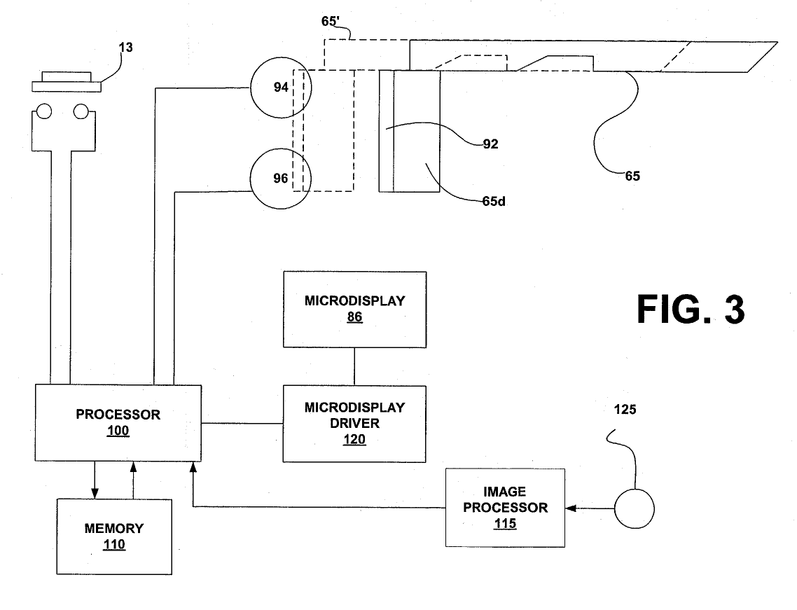

Referring now to FIG. 3, in one preferred embodiment of the present invention, the review cam slide 65 additionally includes a contact arm 65d having a conductive strip 92 thereon. In the shooting mode, the conductive strip 92 does not close the circuit between the electrical contacts 94 and 95 located on the camera pc-board. Images received at the taking lens 125 in response to depression of the trigger button 13 are processed by the image processor 115, which may be a CMOS image sensor, such as the HDCS-2020 by AGILENT, or may be another CMOS or CCD device. The processed image is stored in memory 110 under the control of the processor 100.

Moving the review cam slide 65 from the shooting position to the review position brings the conductive strip 92 into contact with electrical contacts 94 and 95. This closes an electrical circuit that signals the processor 100 that the review mode has been entered. The microdisplay driver 120 and microdisplay 86 are powered only in response to closing of this electrical circuit, which serves to save power and prolong battery life. Once the electrical circuit is closed, the processor 100 controls the redisplay of stored images based on firmware stored in the camera (10 of FIGS. 1A and 1B).

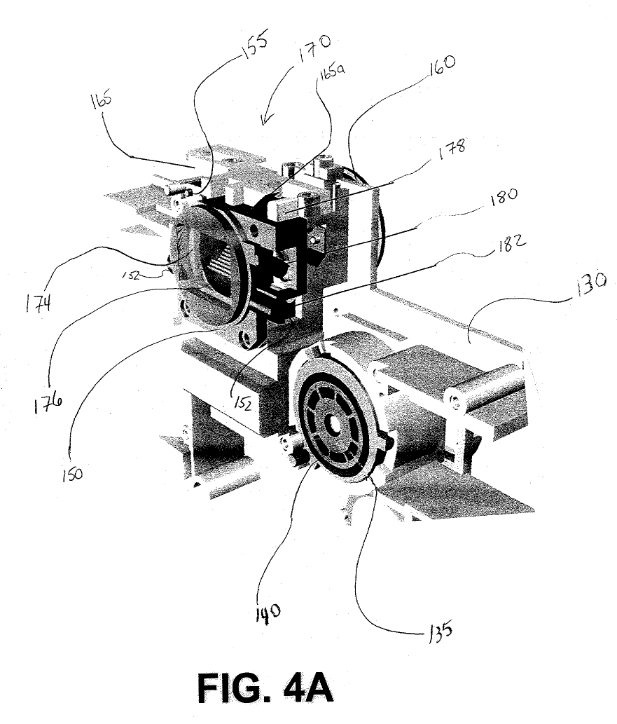

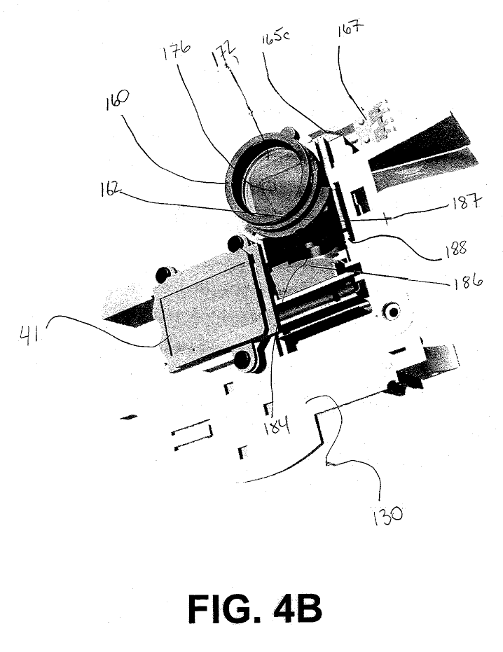

Referring now to FIGS. 4A and 4B, there is shown a specific implementation of one embodiment of the present invention. The internal camera body portion 130 supports the dual-purpose viewfinder assembly. Internal camera body 130 may be molded of plastic or may be provided in some other way and/or of another material. Internal camera body 130 includes openings to receive various elements of the camera assembly. For example, an opening 135 is sized to receive the taking lens and barrel 140. Additionally provided in fixed relationship to the taking lens barrel is a recess sized to receive the negative lens housing 150 of viewfinder assembly 170. Negative lens housing 150 includes sleeve supports 152 which engage the lever arms 182 of the flipping mirror 176. The mirror lever arms 182 are kept in contact with the negative lens housing 150 via the coil spring 180 and a leaf spring 155. The positive lens 172 of the viewfinder assembly 170 is surrounded by a diopter adjustment ring 160, the function of which is described in connection with FIGS. 1A and 1B. The diopter adjustment ring 160 cooperates with a diopter cam 162 to adjust the viewing diopter of the positive lens for a particular user.

The embodiment of FIGS. 4A and 4B includes the flipping mirror 176 and a diving lens group including the loupe lens 184. As described above, the mirror plunger 178 is depressed by the cam surface 165a when the cam slide 165 is moved into the shooting position. In the review mode, the mirror plunger 178 is released and the coil spring 180 pulls the flipping mirror 176 into the raised position.

Loupe lens 184 is aligned between the flipping mirror 176 and the microdisplay 186. The loupe barrel 187 is mounted on the loupe barrel guide pin 188. As described above, when the review cam slide is moved, the cam surface 165c engages the loupe barrel guide pin 188, depressing the pin, and locking it in place under the body of the review cam slide 65. Correspondingly, loupe barrel 187 is locked into its storage position.

The review cam slide 165 additionally includes the conductive wiper contacts 167, which complete an electrical circuit when the cam slide 165 is moved into the review mode position, as described in connection with FIG. 3. Based on the status of the electrical circuit including the wiper contacts 167, the processor selectively provides power to the microdisplay, thus saving power and prolonging battery life.

As such, a camera including the dual-purpose viewfinder of the present described embodiments is operable such that in the “shooting mode” a clear line of sight through the viewfinder is provided. However, when manually switched to the “review mode” the action of sliding the review switch raises a flipping mirror into the direct line of sight of the ocular lens of the viewfinder to permit the user to view stored images reflected from a microdisplay.

While the invention has been described with reference to certain embodiments, it will be understood by those skilled in the art that various changes may be made and equivalents may be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A viewfinder assembly, comprising:
a first ocular lens;
a second objective lens disposed in optical alignment with said first ocular lens and on the same plane as said first ocular lens, a viewfinder line-of-sight path being defined through said first ocular lens and said second objective lens;
a mirror disposed between said first ocular lens and said second objective lens, said mirror operable between a first folded position wherein said mirror is outside the viewfinder line-of-sight path and a second raised position wherein said mirror is raised between said first ocular lens and said second objective lens into the viewfinder line-of-sight path;
a switch operable to move said mirror between said first folded position and said second raised position;
a display for displaying images, said display disposed outside the viewfinder line-of-sight path; and
wherein images displayed on said display are reflected by said mirror to said first ocular lens when said mirror is in said second raised position.

2. The viewfinder assembly of claim 1, including a reverse Galilean lens system wherein said first ocular lens is a positive lens and said second objective lens is a negative lens.

3. The viewfinder assembly of claim 2, wherein said mirror is angled in said second raised position.

4. The viewfinder assembly of claim 3, wherein said mirror is angled at about 45 degrees.

5. The viewfinder assembly of claim 1, further including a magnifying lens disposed between said mirror and said display.

6. The viewfinder assembly of claim 5, wherein said magnifying lens is moveable between a first stored position and a second viewing position in response to the position of said switch.

7. The viewfinder assembly of claim 6, wherein said switch is manually operable between a first switch position and a second switch position.

8. The viewfinder assembly of claim 7, further including a mirror plunger operable to engage said mirror and to drive said mirror into said first folded position when said mirror plunger is depressed, wherein a cam surface on said switch depresses said mirror plunger in said first switch position and releases said mirror plunger in said second switch position.

9. The viewfinder assembly of claim 8, further including a loupe barrel guide pin operable to drive said magnifying lens into said first stored position when said loupe barrel guide pin is depressed, wherein a cam surface on said switch depresses said loupe barrel guide pin in said first switch position and releases said loupe barrel guide pin in said second switch position.

10. A viewfinder assembly, comprising:
a first ocular lens;
a second lens disposed in optical alignment with said ocular lens;
a display for displaying stored images thereon;
a mirror disposed between said first ocular lens and said second lens, and between said first ocular lens and said display, said mirror being operable between a first stored position and a second review position, wherein a captured image path is defined between said first ocular lens and said display when said mirror is in said second review position and wherein a live image path is defined between said first ocular lens and said second lens when said mirror is in said stored position;
a third lens disposed in said captured image path between said display and said mirror, said third lens moveable between a first stored position and a second review position; and
a switch operable to move said mirror and said third lens between said first stored positions and said second review positions.

11. The viewfinder assembly of claim 10, wherein said third lens includes a magnifying lens.

12. The viewfinder assembly of claim 11, wherein said switch includes a slide switch which is manually moved from a first position to a second position.

13. The viewfinder assembly of claim 12, wherein said switch includes a switch plunger in communication with said slide switch, and wherein said switch plunger and said slide switch mechanically drive said mirror from said second review position to said first stored position.

14. The viewfinder assembly of claim 13, additionally including a spring for raising said mirror from said first stored position to said second raised position when said slide switch is moved to said second position.

15. The viewfinder assembly of claim 14, including a reverse Galilean lens system wherein said first ocular lens is a positive lens and said second lens is a negative lens.

16. A digital camera, comprising:
a viewfinder, including,
a first ocular lens;
a second objective lens in optical alignment with said first ocular lens and on the same plane as said first ocular lens, said first ocular lens and said second objective lens defining a viewfinder optical path; and
a mirror disposed between said first ocular lens and said second objective lens, said mirror operable between a first folded position wherein said mirror is outside said viewfinder optical path and a second raised position wherein said mirror is disposed within said viewfinder optical path;
a switch operable to move said mirror between said first folded position and said second raised position;
an image sensor for capturing an image;
a display for displaying images captured by said image sensor, said display disposed outside said viewfinder optical path, wherein images displayed on said display are reflected by said mirror to said first ocular lens when said mirror is in said second raised position; and
control means for selectively causing said image sensor to capture an image and said display to display images captured by said image sensor.

17. The camera of claim 16, wherein said display is only operable when said mirror is in said second raised position.

18. The camera of claim 17, wherein said display is a microdisplay.

19. The camera of claim 16, additionally including a third lens between said microdisplay and said mirror.

20. The camera of claim 19, wherein said third lens includes a magnifying lens.

21. The camera of claim 20, wherein said switch is further operable to move said third lens between a first stored position and a second viewing position.
